(19) United States
(12) Patent Application Publication
(10) Pub. No.: US 2018/0375648 A1
(43) Pub. Date: Dec. 27, 2018

(54) SYSTEMS AND METHODS FOR DATA ENCRYPTION FOR CLOUD SERVICES

(71) Applicant: Citrix Systems, Inc., Fort Lauderdale, FL (US)

(72) Inventors: Feng Huang, Cambridge (GB); Jean-Luc Giraud, Cambridge (GB)

(21) Appl. No.: 15/630,501

(22) Filed: Jun. 22, 2017

(51) Int. Cl. H04L 9/08; H04L 29/06; H04L 9/32; H04L 9/14

(52) U.S. Cl. CPC H04L 9/0827; H04L 9/0861; H04L 9/14; H04L 9/3226; H04L 63/0428

(57) ABSTRACT

Systems and methods for secure storage and transmission of sensitive information in a cloud environment. The methods comprise: receiving sensitive information corresponding to a first resource associated with a first cloud, generating an encryption key for encrypting the sensitive information, encrypting the sensitive information using the encryption key, transmitting the encrypted sensitive information to a cloud connector via a first communication channel, and transmitting the encryption key to a configuration service. The configuration service is associated with a second cloud. The method may further comprise, by a cloud connector: receiving the encryption key from the second resource associated with the second cloud and using the encryption key to decrypt the encrypted sensitive information.

### BACKGROUND

### Statement of the Technical Field

The present disclosure relates generally to cloud computing systems. More particularly, the present invention relates to implementing systems and methods for secure storage and transmission of data in a cloud environment.

### Description of the Related Art

Cloud computing allows a user to utilize applications or services running on a remotely located computer rather than on the user's local computer. For example, data may be processed in the cloud by forwarding the data from a client computer to a server computer, where the data is processed before returning the processed data back to the client computer. This way, the client computer offloads processing tasks to computers in the cloud. While cloud computing has many advantages, processing data in the cloud is not without risk. Because the data to be processed need to be transferred over a computer network, the data is especially vulnerable to online computer security threats, such as eavesdropping, and interception, to name a few examples. Hence, information security is of paramount importance in providing cloud services to one or more users.

Often times, in a cloud computing environment, some resources of an entity are externally managed and located within the cloud of a cloud service provider while other resources of the entity are internally managed by the entity and located within an its own servers or other computing devices. External cloud servers, however, are public-facing, and as such, some entities may be reluctant to use applications that require access to sensitive information. Furthermore, a user may send sensitive information or information (such as identity credentials) to an internally managed application or other resource located in one of the entity's computing devices where the sensitive information may be transmitted from the user's device to the internal resource via an external cloud provided by the cloud service provider. As a result, the cloud service provider may disadvantageously have access to the sensitive information. For example, a cloud service provider may control access to various resource or applications via a single sign-on system where a password manager (a software application/agent/process/etc.) running on the network or system of the cloud service provider is responsible for providing user credentials to secure applications. The user credentials for a particular user are usually stored in encrypted form in a location accessible to the password manager after being encrypted using a cryptographic key associated with the user. Requests by an authenticated user to access a secure application which require a user credential are intercepted by the password manager, and hence may be accessible by the cloud service provider. Additionally, the storing of an intact cryptographic key associated with the user represents a security vulnerability as the key could be stolen by malicious entities thereby exposing the sensitive information such as identity credentials.

Further, if the cloud service provider indirectly routes the sensitive information, as cloud service providers relay thousands of communications at any given point in time, an unintended recipient may also obtain the sensitive information.

### SUMMARY

Implementing systems and methods for secure storage and transmission of sensitive information in a cloud environment. The method may include by a processor: receiving sensitive information corresponding to a first resource associated with a first cloud, generating an encryption key for encrypting the sensitive information, encrypting the sensitive information using the encryption key, transmitting the encrypted sensitive information to a cloud connector via a first communication channel, and transmitting the encryption key to a configuration service. The configuration service may be associated with a second cloud. In some scenarios, the cloud connector is associated with a cloud that is different from the second cloud. The sensitive information may include identity credentials for authenticating a user requesting access to the first resource.

In some scenarios, transmitting the encryption key to the configuration service may include transmitting the encryption key via a second communication channel, wherein the second communication channel is different from the first communication channel. In some such scenarios, the first communication channel and/or the second communication channel are secured communication channels.

In some scenarios, the methods may also include deleting the encryption key after transmission of the encryption key to the configuration service.

In some other scenarios, the methods may further include receiving by a second resource associated with the second cloud, a request from a user to cause the first resource to perform an action. In such scenarios, the methods may also include, by the second resource, in response to receiving the request: retrieving the encryption key from the configuration service, and transmitting the encryption key and the request to the cloud connector. In such or other scenarios, the encryption key may be transmitted to the cloud connector via a third communication channel. The cloud connector may then receive the encryption key from the second resource, use the encryption key to decrypt the encrypted sensitive information, and transmit the request and the decrypted sensitive information to the first resource.

In some scenarios, the methods may also include, by the cloud connector: receiving the encryption key from a second resource associated with the second cloud, using the encryption key to decrypt the encrypted sensitive information, authenticating the user using the decrypted sensitive information, and upon successful authentication, transmitting the request to the first resource. In such scenarios, the cloud connector may delete the decrypted sensitive information.

### BRIEF DESCRIPTION OF THE DRAWINGS

Embodiments will be described with reference to the following drawing figures, in which like numerals represent like items throughout the figures.

FIG. 1 is an illustration of an exemplary system.

FIG. 2 is an illustration of an exemplary computing device.

FIG. 3 is an illustration of an exemplary cloud computing environment.

FIG. 4 is a flowchart illustrating an example method for the secure transmission and storage of sensitive information through a cloud environment.

FIG. 5 is a message flow diagram illustrating an example method for secure storage of identity credentials in a cloud computing environment.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The term “sensitive information,” as used herein, refers to data that must be protected from unauthorized access to protect the privacy and/or security of a user or an entity. Examples may include access credentials required for accessing a resource (e.g., username, password, personal identification number, biometric information, 2-factor authentication credentials, knowledge based authentication credentials, or the like), personal information, medical information, financial information, unique identifiers such as social security information, biometric data, trade secrets, customer and supplier information, employee data, or the like. The “identity credentials” as used herein include, without limitation, domain passwords, user IDs, tokens, or smart cards, biometrics, SAML assertions, other types of assertions and any other information provided by a user or on a user's behalf in order to authenticate the user to the network or system hosting a secure resource the user is requesting access to.

The term “communication channel” as used herein is a path, conduit, logical channel or any means of communication that enables or supports a communication interaction or an exchange of information between two parties, such as different computing devices in a cloud computing environment. A communication channel may be wired or wireless.

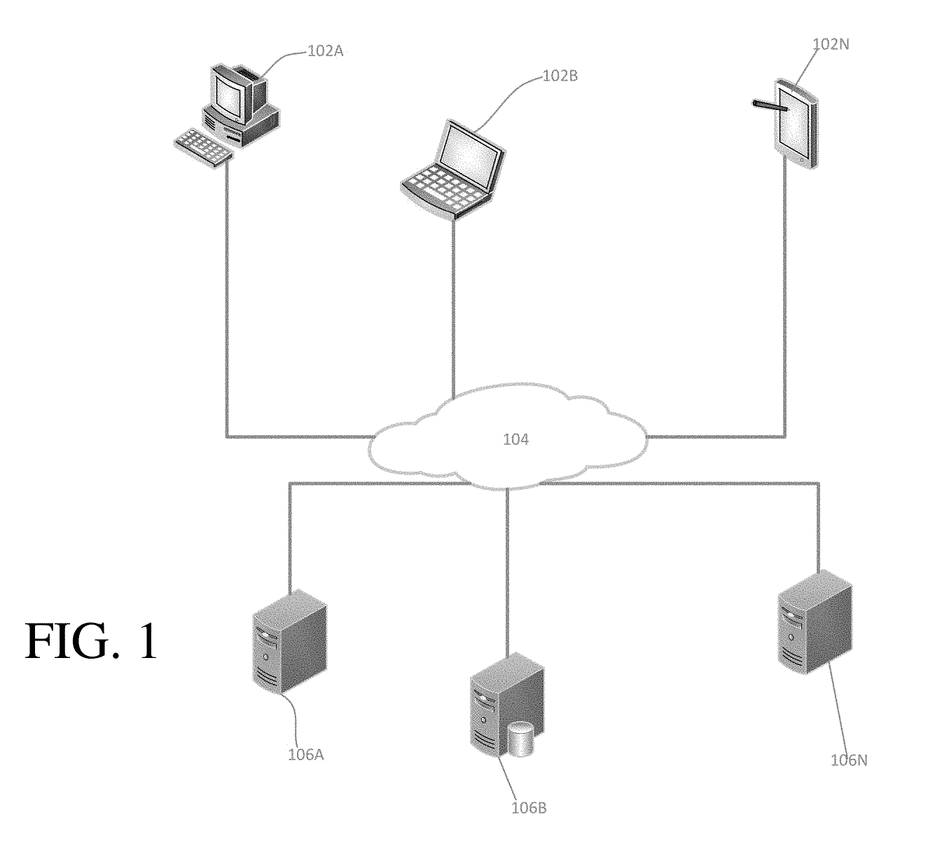

Referring now to FIG. 1, a schematic block diagram illustrating an example computing environment in which the embodiments described herein may be implemented is shown. FIG. 1 illustrates one embodiment of a computing environment 101 that includes one or more client machines 102A-102N (generally referred to herein as “client machine(s) 102A-N”) in communication with one or more servers 106A-106N (generally referred to herein as “server(s) 106A-N”). Installed in between the client machine(s) 102A-N and server(s) 106A-N is a network 104.

In one embodiment, the computing environment 101 can include an appliance installed between the server(s) 106A-N and client machine(s) 102A-N (not shown here). This appliance may manage client/server connections, and in some cases can load balance client connections amongst a plurality of backend servers. For example, the appliance may be a cloud management server and/or a cloud connector that may provide a communication link between the client machine(s) 102A-N and the server(s) 106A-N for accessing computing resources (cloud hardware and software resources) hosted by the server(s) 106A-N in a cloud-based environment. The cloud hardware and software resources may include private and/or public components. For example, a cloud may be configured as a private cloud to be used by one or more particular customers or client computers and/or over a private network. In other embodiments, public clouds or public-private clouds may be used by other customers over open or closed networks.

The client machine(s) 102A-N can in some embodiment be referred to as a single client machine or a single group of client machines, while server(s) 106A-N may be referred to as a single server or a single group of servers. In one embodiment, a single client machine communicates with more than one server, while in another embodiment a single server communicates with more than one client machine. In yet another embodiment, a single client machine communicates with a single server.

Client machine(s) 102A-N can, in some embodiments, be referenced by any one of the following terms: client machine(s); client(s); client computer(s); client device(s); client computing device(s); local machine; remote machine; client node(s); endpoint(s); endpoint node(s); or a second machine. The server(s) 106A-N, in some embodiments, may be referenced by any one of the following terms: server(s), local machine; remote machine; server farm(s), host computing device(s), or a first machine(s).

In one embodiment, one or more of the client machine(s) 102A-N can be a virtual machine. The virtual machine can be any virtual machine, while in some embodiments the virtual machine can be any virtual machine managed by a hypervisor developed by Citrix Systems, IBM, VMware, or any other hypervisor. In other embodiments, the virtual machine can be managed by any hypervisor, while in still other embodiments, the virtual machine can be managed by a hypervisor executing on a server or a hypervisor executing on a client machine.

The client machine(s) 102A-N can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include one or more client machine(s) 102A-N that display application output generated by an application remotely executing on a server(s) 106A-N or other remotely located machine. In these embodiments, the client machine(s) 102A-N can display the application output in an application window, a browser, or other output window. In one embodiment, the application is a desktop, while in other embodiments the application is an application that generates a desktop.

The server(s) 106A-N, in some embodiments, execute a remote presentation client or other client or program that uses a thin-client or remote-display protocol to capture display output generated by an application executing on a server and transmit the application display output to a remote client machine(s) 102A-N. The thin-client or remote-display protocol can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

The computing environment 101 can include more than one server(s) 106A-N such that the server(s) 106A-N are logically grouped together into a server farm. The server farm can include servers that are geographically dispersed and logically grouped together in a server farm, or servers that are located proximate to each other and logically grouped together in a server farm. Geographically dispersed servers within a server farm can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm may be administered as a single entity, while in other embodiments the server farm can include multiple server farms.

In some embodiments, a server farm can include server(s) 106A-N that execute a substantially similar type of operating system platform (e.g., WINDOWS, manufactured by Microsoft Corp. of Redmond, Wash., UNIX, LINUX or macOS.) In other embodiments, the server farm can include a first group of servers that execute a first type of operating system platform, and a second group of servers that execute a second type of operating system platform. The server farm, in other embodiments, can include servers that execute different types of operating system platforms.

In some embodiments, computing environment 101 can include more than one server(s) 106A-N such that the server(s) 106A-N are divided into one or more sub-group, each of which is managed and/or operated by a different entity. For example, a first entity may operate and/or manage a first sub-group of server(s) on premise, in a private cloud or in a public cloud, a second entity may operate and/or manage a second sub-group of server(s) on premise, in a private cloud or in a public cloud, a third entity may operate and/or manage a third sub-group of server(s) on premise, in a private cloud or in a public cloud, and so on.

The server(s) 106A-N, in some embodiments, can be any server type. For example, a server can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server executing an active directory; or a server executing an application acceleration program that provides firewall functionality, application functionality, or load balancing functionality. In some embodiments, a server may be a RADIUS server that includes a remote authentication dial-in user service. In embodiments where the server comprises an appliance, the server can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a first server 106A that receives requests from one or more client machine(s) 102A-N, forwards the request to a second server 106B, and responds to the request generated by the client machine(s) 102A-N with a response from the second server 106B. The first server 106A can acquire an enumeration of applications available to the client machine(s) 102A-N and well as address information associated with an application server hosting an application identified within the enumeration of applications. The first server 106A can then present a response to the client's request using a web interface, and communicate directly with the client machine(s) 102A-N to provide the client machine(s) 102A-N with access to an identified application.

The server(s) 106A-N can, in some embodiments, execute any one of the following applications: a thin-client application using a thin-client protocol to transmit application display data to a client; a remote display presentation application, or the like. Another embodiment includes a server that is an application server such as: an email server that provides email services such as MICROSOFT EXCHANGE manufactured by the Microsoft Corporation; a web or Internet server; a desktop sharing server; a collaboration server; or any other type of application server. Still other embodiments include a server that executes any one of the following types of hosted servers applications: WEBEX provided by WebEx, Inc. of Santa Clara, Calif.; or Microsoft Office LIVE MEETING provided by Microsoft Corporation.

Client machine(s) 102A-N can, in some embodiments, be a client node that seek access to resources provided by a server. In other embodiments, the server(s) 106A-N may provide client machine(s) 102A-N with access to hosted resources. The server(s) 106A-N, in some embodiments, may function as a master node such that it communicates with one or more client machine(s) 102A-N or server(s) 106A-N. In some embodiments, the master node can identify and provide address information associated with a server hosting a requested application, to one or more clients or servers. In still other embodiments, the master node can be a server farm, a client machine, a cluster of client nodes, or an appliance.

One or more client machine(s) 102A-N and/or one or more server(s) 106A-N can transmit data over a network 104 installed between machines and appliances within the computing environment 101. The network 104 can comprise one or more sub-networks, and can be installed between any combination of the client machine(s) 102A-N, server(s) 106A-N, computing machines and appliances included within the computing environment 101. In some embodiments, the network 104 can be: a local-area network (LAN); a metropolitan area network (MAN); a wide area network (WAN); a primary network comprised of multiple sub-networks located between the client machines 102A-N and the servers 106A-N; a primary public network with a private sub-network; a primary private network with a public sub-network 4; or a primary private network with a private sub-network. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices.

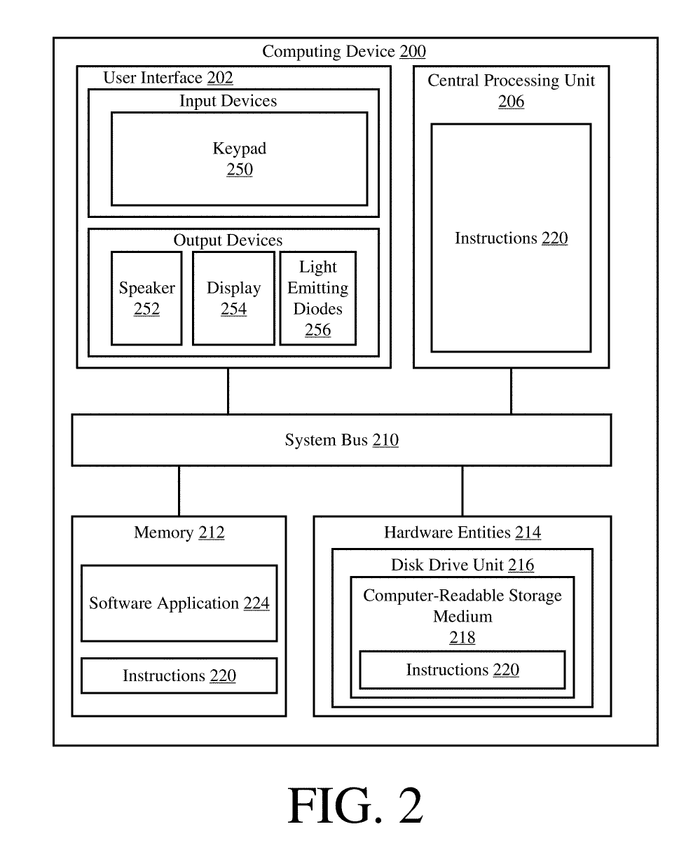

Referring now to FIG. 2, there is provided a detailed block diagram of an exemplary architecture for a computing device 200, where the client machine 102 and server 106 illustrated in FIG. 1 can be deployed as and/or executed on any embodiment of the computing device 200. As such, the following discussion of computing device 200 is sufficient for understanding client machine(s) 102 and/or server(s) 106 of FIG. 1.

Computing device 200 may include more or less components than those shown in FIG. 2. However, the components shown are sufficient to disclose an illustrative embodiment implementing the present solution. The hardware architecture of FIG. 2 represents one embodiment of a representative computing device configured to facilitate storage and/or transmission of sensitive information in a cloud computing environment. As such, the computing device 200 of FIG. 2 implements at least a portion of a method for (a) encryption of sensitive information, and (b) transmission and/or storage of encrypted sensitive information in a cloud computing environment via a plurality of communication channels, as discussed below.

Some or all the components of the computing device 200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (“CPU”) 206, a system bus 210, a memory 212 connected to and accessible by other portions of computing device 200 through system bus 210, and hardware entities 214 connected to system bus 210. The user interface can include input devices (e.g., a keypad 250) and output devices (e.g., speaker 252, a display 254, and/or light emitting diodes 256), which facilitate user-software interactions for controlling operations of the computing device 200.

At least some of the hardware entities 214 perform actions involving access to and use of memory 212, which can be a RAM, a disk driver and/or a Compact Disc Read Only Memory (“CD-ROM”). Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 222 for execution by the computing device 200 and that cause the computing device 200 to perform any one or more of the methodologies, as described herein.

In some scenarios, the hardware entities 214 include an electronic circuit (e.g., a processor) programmed for facilitating (a) encryption of sensitive information, and (b) transmission and/or storage of encrypted sensitive information in a cloud computing environment via a plurality of communication channels. In this regard, it should be understood that the electronic circuit can access and run a software application 224 installed on the computing device 200. The functions of the software application 224 will become apparent as the discussion progresses.

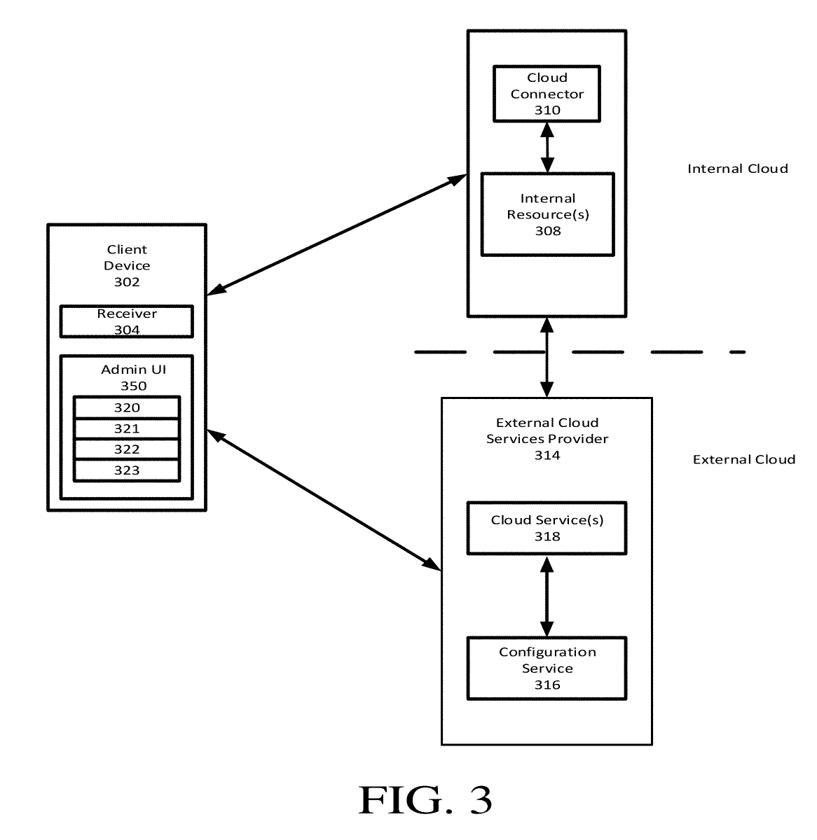

Referring now to FIG. 3, an illustrative cloud computing system that may be used to implement one or more illustrative aspects described herein is shown. Cloud computing environment 300 may include more or less components than those shown in FIG. 3. However, the components shown are sufficient to disclose an illustrative embodiment implementing the present solution. Some or all the components of the computing environment 300 can be implemented as hardware, software and/or a combination of hardware and software, arranged to and/or programmed to perform one or more of the methodologies, procedures, or functions described herein.

As shown in FIG. 3, the cloud computing environment 300 comprises an external cloud service provider 314 for providing public cloud services and resources. The cloud computing environment further comprises a client device 302, and an internal cloud comprising a cloud connector 310 which facilitates communications between the internal cloud and the external cloud service provider 314.

The system 300 may be in the form of a cloud computing environment in which some resources of an entity are externally managed and located within the cloud of a cloud service provider while other resources of the entity are internally managed by the entity and located within the entity's own servers or other computing devices (internal resources 308). As used herein, variations of the term “internal” may refer to resources and applications managed by an entity itself and/or stored on one or more computing devices controlled by the entity and not controlled by an external cloud service provider. As an example, a resource may be stored at an on-premises server of the entity for remote access by authorized users associated with the entity. For instance, a particular software application (e.g., an internal resource) may be stored on a server controlled and managed by an employer, and may be accessed by one or more of its employees. As used herein, variations of the term “external” may refer to resources and applications managed by a cloud service provider and/or are stored on one or more computing devices controlled by the external cloud service provider. As an example, an external resource may be stored at a cloud-based server of the external cloud service provider for access by authorized users associated with the entity. In such an example, the external resource may also be associated with the entity. Resources (external and/or internal) may include, without limitation, a network, a file, data, a computing device, an application, a module, a cloud service, a function, or any other entity.

A user of a cloud computing environment (e.g., cloud computing environment 300) may wish to access an internal resource installed on a geographically remote internal computing device and/or access or use an external resource located on an external server. The user may connect and/or otherwise communicate with the internal resource and/or the external resource via an external cloud service. In some instances, the user may have to provide the identity credentials (e.g., username and password) to the internal resource and/or the external resource for authentication in order to gain access to the internal resource and/or the external resource. In such instances, the identity credentials may be reversibly encrypted and sent to the internal resource and/or the external resource via the external cloud service, which may then be decrypted and used by the internal resource and/or the external resource as will be discussed in further detail below. It will be understood that other types of sensitive information may also be reversibly encrypted and sent to the internal resource and/or the external resource via the external cloud service using principles described herein.

The cloud computing environment 300 may include an external cloud services provider 314 to provide public cloud services and resources. External cloud services provider 314 may include applications and/or other resources stored in its computing devices (not shown) that users can access over the Internet. External cloud services provider 314 may also transfer information from a particular internal computing device to another internal computing device at different premises of an entity that might not be part of external cloud services provider 314. As an example, a computing device that is part of a private cloud located at a particular geographic location may send information via the external cloud to another computing device that is also part of the private cloud of the entity (or may be a different private cloud of the entity) located at a different geographic location.

The external cloud services provider 314 may include various external resources and/or services (“cloud service(s) 318”). Examples of cloud services may include, without limitation, configurations services, single-sign on password services for on-premises active directories, authentication services (e.g., knowledge based authentication services, 2^{nd} factor authentication services, etc.), self-service password reset services (SSPR services), on-premises active directory access services, data store access services, or the like.

In an embodiment, a configuration service 316 (also referred to as the “configuration service”) may handle all inter service communication within the cloud for the cloud services provider 314 (and/or the internal resources). The configuration service 316 may hold and manage a list of all services for the external cloud services provider, allowing them to advertise their addresses, or endpoints including the functionality that they provide. Only after a service successfully registers with the configuration service will it become active and able to communicate with other services and applications. Once done, the configuration service 316 will share a listing of all active and registered services as being active services. The configuration service 316 may store any service directory or list and related information into a configuration storage. The configuration storage may include any type and form of storage and/or memory, such as those described in connection with FIGS. 1 and 2. The information related to each service may be stored separately or together in the configuration storage and may be stored in any type of format. In an embodiment, the configuration service 316 may also store identity credentials, encryption keys, sensitive information, or the like.

The cloud computing environment 300 may include a client device 302, which may be a personal computer, laptop, tablet, smartphone, etc. and may include one or more components of a computing device discussed above. In an embodiment, the client device 302 may be a remote computing device such as user's personal device (e.g., the user may own client device 302) and may be able to login and/or otherwise access the internal cloud and/or the external after the user has been authenticated. In other instances, client device 302 may be owned by the entity managing and controlling the internal cloud (e.g., an employer-provided laptop). In such instances, when the user connects to client device 302 to a terminal at the premises of the entity, client device 302 may be part of the internal cloud. Otherwise, when the user uses client device 302 outside of the premises of the entity (e.g., at the user's home), client device 302 might not be part of the internal cloud but may be able to login and/or otherwise access the internal cloud after the user has been authenticated (e.g., via a virtual private network (VPN) connection).

The client device 302 may include a web browser 306 and a program such as a receiver 304, which may be a client software installed on client device 302. The receiver 304 may enable the client device 302 to access internal and/or external cloud services. The web browser 306 may enable the client device 302 to securely access certain applications that are managed, configured, and/or provided by an external cloud service provider but executed on the client device 302 (rather than via a remote session). This allows a user to take advantage of local processing power while still allowing administrators to centrally manage licensing and configuration. For example, an administrator can configure and publish, for example, an encryption application, an authentication application, or the like, which may be executed on the client device 302 to take advantage of the local processor without incurring network delays. Such applications may be published for use by the client device 302 by for example, an Administration User Interface (“Admin UI”) 350. Other examples may include, without limitation, graphics UI, low-level software development kit (SDK), or the like. In another example, client device 302 may, using receiver 304, securely access applications, virtual desktops and data stored in the internal and/or external clouds. In an example, receiver 304 may be a Citrix Receiver developed by Citrix Systems, Inc. of Ft. Lauderdale, Fla.

The client device 302 may also include a data encryption module 320 configured for encryption of sensitive information. Alternatively and/or additionally, the client device may access and use a data encryption module 320 configured for encryption of sensitive information published by an Admin UI 350 and accessed by the client device 302 using a web browser 304. The data encryption module 320 may include a key generator 321, a key exchange module 322, and an encryptor 323. The key generator 321 may generate symmetric and/or asymmetric encryption keys (discussed below) for encryption of sensitive information. The key may be generated using a random key generator, a pseudo-random key generator, or any other key generator.

The key exchange module 322 may be configured for securely transmitting one or more symmetric or asymmetric encryption keys to the configuration service 316 of the external cloud via a communication channel. In an embodiment, the communication channel may also be secure or encrypted such that the external cloud services provider 314 or an unauthorized entity cannot access the encryption keys. Secured communication channel can be based on, for example, secured socket layer (SSL) protocols implemented on top of any transport layer protocols, such as transmission control protocol (TCP), transport layer security (TLS), or the like. SSL protocols can also be used together with application-specific protocols, such as HTTP (to form HTTPS), FTP, etc.

The configuration service 316 may store the encryption keys and may transmit the stored encryption keys to an internal resource and/or external resource or service via another communication channel. Upon receipt of the key at the configuration service 316, the key generator 321 may destroy (i.e., delete) the key from its memory.

The encryptor 323 may be configured to reversibly encrypt data such as sensitive information with an encryption key generated by the key generator 321 to create encrypted data. It should be clear that the encryptor 323 can encrypt the data by performing any type of manipulation on the data now or hereafter known to those skilled in the art.

In one embodiment, the encryptor 323 may be a software module that executes mathematical algorithms on the key and the sensitive information to create the encrypted sensitive information. Those skilled in the art will recognize that exact encryption techniques used to implement the present invention may vary within the scope of the embodiments described herein.

Encryption, as used herein, may include any one or more of various means, methods, systems, functions, etc. for transforming data from an interpreted form and securing it by a process that renders the data uninterpretable to anyone but those that are able to decrypt the encrypted data. Encryption may also include to a wide variety of encryption standards and techniques, including private key and public key encryption. Encryption and decryption may be accomplished via a system implementing passwords, keys, or a combination of both. Encryption schemes may include symmetric-key encryption schemes where secret keys are exchanged between the party seeking to encrypt data and the party seeking to decrypt data. Such schemes may also include “shared secret” or “pre-shared” encryption schemes. Examples of such encryption schemes may include the Advanced Encryption Standard, Blowfish, Twofish, Serpent, CASTS, RC4, 3DES and IDEA.

Some aspects, features, or embodiments described herein may make use of public/private key encryption. Public key encryption may include any method or methods for transforming data into a form that can only be interpreted by the intended recipient, recipients, or otherwise intended audience. Public key encryption methods may involve the use of asymmetric key algorithms (e.g., DSS and RSA), where a key necessary to encrypt data is different from the key needed to decrypt the data. This allows the key with which to encrypt said data, the “Public Key,” to be shared widely. Integrity of security is maintained because the separate key with which to decrypt the encrypted information remains secret. The secret key may also be a private key, and the combination of a public key and corresponding private key may be a public-private key pair. Thus, public key encryption does not require a secure initial exchange of one or more secret keys.

Some aspects, features, or embodiments described herein may use public keys or public key encryption, or alternatively or additionally may use any other form of encryption, including private key encryption or any other form of encryption.

Some aspects, features, or embodiments described herein may make use of symmetric-key or shared secret encryption. Alternatively, some aspects, features, or embodiments may use any other form of encryption to successfully implement the systems and methods disclosed herein, including public key encryption or any other form of encryption.

Some aspects, features, or embodiments described herein may make use of a “shared key” or “sharing keys” for the purposes of encryption or decryption. Shared keys may include keys that may be shared between a particular group of users. A shared key may be any type or form of key used in any type or form of encryption scheme or standard. In some examples, a shared key may be unique to a particular file or may be shared with only a single user, application, or process. Additionally or alternatively, a shared key may be an asymmetric private/public key pair.

Referring back to FIG. 3, the internal cloud of the cloud computing environment 300 may also include a cloud connector 310, which may analyze, intercept and/or forward messages being sent to the internal cloud from the external cloud, and vice versa. In an embodiment, the cloud connector 310 may not be a part of the internal cloud. The internal cloud may also include one or more internal resources 308. The cloud connector facilities communications between the services in the public cloud (cloud service(s) 318) and the internal resource(s) 308. In an embodiment, the cloud connector 310 may include or may access one or more authentication modules or services for authenticating a user requesting access to a secure resource. An authentication module may authenticate a user based on identity credentials such as, without limitation, password-based authentication, knowledge based authentication, biometric based authentication, 2^{nd} Factor authentication, or the like.

In an embodiment, a cloud service 318 maybe configured such that it may require and/or cause one or more actions to be performed by an internal resource 308 during the provision of the cloud service. However, before authorizing the performance of such an action, the internal resource 308 may require the presentation of sensitive information (e.g., a password). For example, execution of a password reset service for changing a password associated with an internal resource (e.g., on-premises active directory) using a cloud service (e.g., an SSPR service) requires the SSPR service to cause the on-premises active directory to perform the password reset. However, before the on-premises directory may authorize the password reset, it may require the SSPR service to provide sensitive information such as an old password, authentication information for authenticating a user, or the like. However, storing such sensitive information in the cloud service 318 may lead to security issues.

Hence, in an embodiment, upon receipt of sensitive information, at a client device 302 for the first time, that may later be used by a cloud service 318 to cause an internal resource 308 to perform a desired action, the encryption module 320 included in and/or accessed (via, for example, an Admin UI) by the client device 302 maybe used to create a key and encrypt the sensitive information in with the key. The encryption module 320 may then send the generated key to the configuration service 316 of the cloud services provider 314, and the encrypted sensitive information to the cloud connector 310. This ensures that the cloud service 318 does not have access to and/or does not store the sensitive information in encrypted and/or unencrypted form. At a later time, when the cloud service 318 requires an action to be performed by an internal service 308, the cloud service 318 may request a copy of the encryption key from the configuration service 316, and send the received key to a cloud connector 310 (that stores the encrypted sensitive information) directly or indirectly (via another cloud service) depending on whether the cloud connector 310 is reachable from the client device 302. The cloud connector 310 may use the key to decrypt the stored encrypted sensitive information, using the received key, and request the required action from the internal service 308 by providing the decrypted sensitive information for authentication.

It will be understood to those skilled in the art that the cloud environment described above for transmission and storage of information between an internal cloud and an external cloud, is intended to be illustrative and in no way limiting as to the type of architecture that may be deployed to support the embodiments described herein Similar principles may be applied for storage and transmission of information between any two cloud environments, such as, without limitation internal clouds of two different entities, internal clouds of a single entity, two external clouds, and/or an internal cloud and an external cloud.

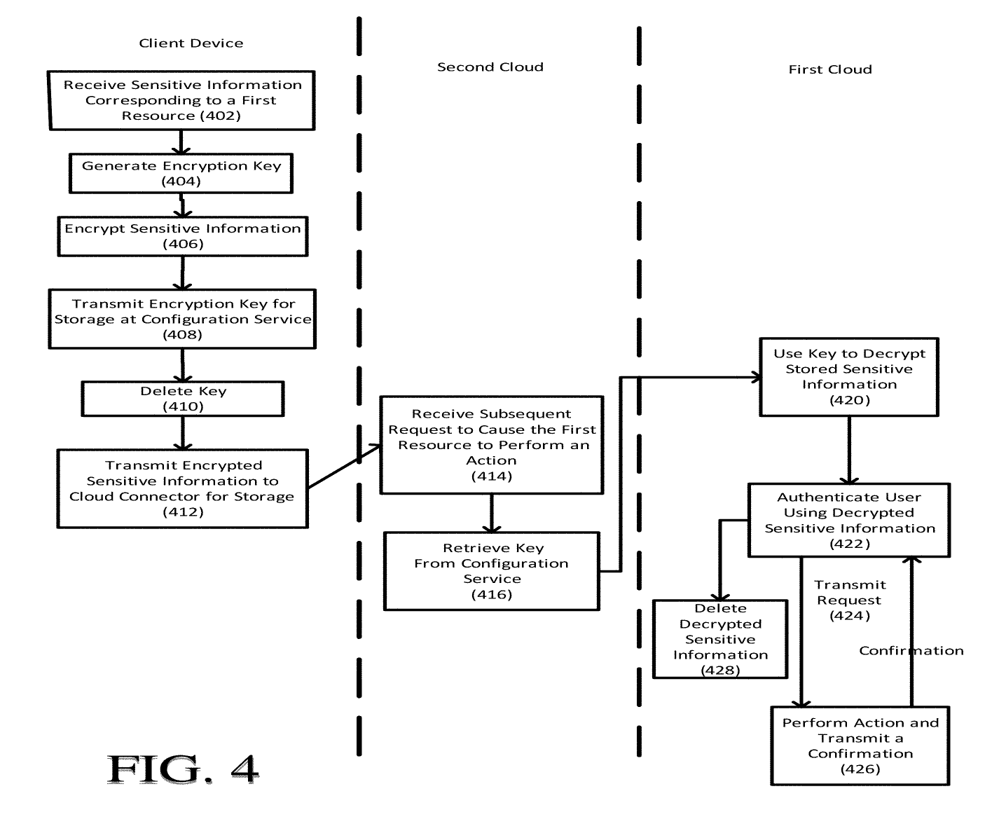

Referring now to FIG. 4, an example method 400 for the secure transmission and/or storage of sensitive information in a cloud environment is illustrated. An example cloud environment 300 is illustrated in FIG. 3. Process 400 may be performed by a system, such as system 100. For example, in one or more embodiments, the process 400 illustrated in FIG. 4 and/or one or more steps thereof may be performed by a computing device (e.g., any device of FIGS. 1-2). In other embodiments, the process illustrated in FIG. 4 and/or one or more steps thereof may be embodied in computer-executable instructions that are stored in a computer-readable medium, such as a non-transitory computer-readable memory. Alternatively or additionally, any of the steps in process 400 may be performed on any client device, gateway device, cloud connector, external cloud provider, and/or third-party server, or computing device. Alternatively or additionally, any of the steps in process 400 may be performed on any browser plug-in, an Admin UI, or the like.

The method 400 may begin at 402 when a client device of the cloud environment receives sensitive information. In an embodiment, the client device may receive identity credentials that may subsequently be used to access a first resource (associated with a first cloud) and/or cause the first resource to perform a desired action. For example, the client device may receive the identity credentials for accessing a resource during the user's initial authentication during log-on. In an embodiment, the client device may receive the information for transmission to a recipient, such as, for example, the first resource, another resource associated with the first cloud, and/or another resource on a different cloud from that of the first resource, for subsequent login usage. However, the client device may intercept the sensitive information and store it in an encrypted form at a cloud connector, as discussed below. This ensures that unencrypted sensitive information is not transmitted to and/or stored at an untrusted entity such as, for example, a cloud that is not the first cloud or a resource that is not the first resource. For example, an administrator may provide sensitive information that includes a privileged password for authorizing a user to change the user's access credentials corresponding to one or more resources using an SSPR service. The first resource may be any internal and/or external resource.

In an embodiment, the client device may identify that the information received includes sensitive information that may be used to access a first resource and/or cause the first resource to perform a desired action, based on, for example, content of the information (e.g., keyword, tags, etc.), type of the information, user information (e.g., when the user is an administrator), sender device information, recipient resource or application description, intended use of the information, or the like. For example, the client device may determine that the received information contains sensitive information if it includes keywords such as password, username, social security number, account number, or the like. In another example, the client device may determine that the received information contains sensitive information if it includes an authentication token for authenticating a user or a device. Sensitive information may include, without limitation, user identity (e.g., user number, username, etc.) and/or password, personal identification number (PIN), smart card identity, security certificates (e.g., a public key certificate), and features of the user (e.g., as captured by a sensor, such as a fingerprint reader, iris scan, voice recognizer, or other biometric, etc.), or any data used for authentication to access a particular application or resource.

Upon receipt of sensitive information, the client device may use an encryption module (included in the client device and/or published by an Admin UI via a browser) to generate a key (404) for encryption of the sensitive information, and encrypt 406 the sensitive information, as discussed above.

Upon encryption, the client device may transmit 408 the generated key to a configuration service (or another service, resource or computing device) for storage, via a first communication channel. In an alternate embodiment, the configuration service may be associated with a second cloud that is not the first cloud.

In an embodiment, the client device may delete 410 the key from memory. The client device delete the key from memory upon receipt of a message from the configuration service confirming the receipt of the key. This prevents the client device from deleting the key before the configuration service successfully receives the key. By not deleting the key until receiving the acknowledgement message, the client device can retransmit the key to the configuration service upon a failure in the transmission. Alternatively, the client device may delete the key immediately upon transmission of the encryption key to the configuration service. By deleting the key, the client device does not have the mechanism needed to decrypt the encrypted information. Thus, an unauthorized entity may only retrieve the encrypted information by, for example hacking into a device, but cannot decrypt the encrypted information (and so cannot use the information).

In an embodiment, the client device may also delete the unencrypted sensitive information from memory after encryption.

Upon encryption, the client device may also transmit 412 the encrypted sensitive information to a cloud connector for storage, via a second communication channel that is separate and distinct from the first communication channel. In an embodiment, communication channels may be different in various aspects, such as connection time, location, media type, mode of signal modulation, signal polarization, carrier frequency, etc. For example, the communication protocols, communication networks and/or communication media on first communication channel are different from the communication protocols, communication networks, and/or communication media on second communication channel. In certain embodiments, communication channels may refer to physical transmission medium, such as wires, cables, or other physical signal carrying medium, or wireless communication medium such as radio signals or electro-magnetic wave signals. In an embodiment, each of the communication channels may be configured with a unique IP address to eliminate the possibility of an eavesdropper identifying the key and the encrypted message by correlating the transmissions from multiple related servers. Alternatively, proxy servers may be used to ensure that the data is delivered from unique IP addresses. Furthermore, as discussed above, one or more of the communication channels may be secured for additional security.

In an embodiment, the client device may send the encrypted sensitive information to the cloud connector directly. Alternatively and/or additionally, the client device may send the encrypted sensitive information to the cloud connector indirectly via, for example, a resource and/or service of the cloud environment.

In an embodiment, the cloud connector may be associated with a cloud that is not the second cloud and so is not associated with the configuration service. In an embodiment, the cloud connector may be associated with the first cloud. Thus, sensitive information required for accessing the first resource is stored in an encrypted form at a cloud connector associated with one cloud, and the key for decrypting the information is stored at a configuration service associated with another cloud that is different from the cloud associated with the cloud connector. Furthermore, by transmitting the encrypted information over a communication channel separate and distinct from the communication channel used for transmitting the key, an unauthorized entity may only retrieve the encrypted information from the second communication channel but cannot decrypt the encrypted information without the key that is transmitted using a different channel (and so cannot use the information). Furthermore, during transit (i.e., before delivery to an intended recipient), the key and the encrypted information are stored by separate components of the cloud computing environment—key at the configuration service associated with one cloud and encrypted information at the cloud connector associated with another cloud—for additional security.

At 414, a second resource may subsequently receive a request from a user to cause the first resource to perform an action. In an embodiment, the second resource may be associated with a cloud that is the first cloud. Alternatively, the second resource may be associated with a cloud that is not the first cloud. For example, a user may request access to an active directory (first resource) for changing a user's password (action), via an SSPR service (second resource). In an embodiment, the request may include the user's identity credentials that must be authenticated by, for example, comparison with stored identity credentials, before the request for causing the first resource to perform the requested action is granted. In an embodiment, the second resource may receive the request from a user via a client device (e.g., receiver).

Upon receipt of the request, the second resource may retrieve 416 the key used for encryption of the sensitive information from the configuration service, and may transmit 418 the key and the user request to the cloud connector where the sensitive information (including the identity credentials) is stored. In an embodiment, the second resource may use a third communication channel to retrieve the key from the configuration service, and a fourth communication channel for transmitting the key and the user request to the cloud connector, where the third and fourth communication channels. In an embodiment, the third and fourth communication channels are separate and distinct from each other. In an alternate embodiment, the third and fourth communication channels are the same. In yet another embodiment, the third communication channel is separate and distinct from the first communication channel and/or the second communication channel, and the fourth communication channel is separate and distinct from the first communication channel and/or the second communication channel.

The cloud connector may use the key to decrypt 420 the sensitive information and use the decrypted sensitive information to authenticate 422 the user (by, for example, comparing the received identity credentials with the identity credentials included in the decrypted sensitive information using an appropriate authentication module).

If the user is authenticated by the cloud connector, the cloud connector may transmit 424 the user request to the first resource with an assertion provides a confirmation to the first resource that the user has been authenticated to perform the action. Alternatively and/or additionally, the cloud connector may forward the decrypted sensitive information to the first resource along with the user request without performing the authentication, and the first resource may authenticate the user using the decrypted sensitive information.

At 426, the first resource may execute the user requested action and transmit a confirmation to the cloud connector. Upon receipt of the confirmation that the requested action was successfully executed, the cloud connector may discard 428 the decrypted sensitive information. The cloud connector may also forward the confirmation to the user.

It will be understood to those skilled in the art that while the embodiments described herein comprise storing the encryption key at a configuration service, other computing devices or modules of a cloud that is not the first cloud may store the key, without deviating from the principles disclosed herein. For example, encryption keys may be stored by a single sign-on service of a second cloud. It will also be understood to those skilled in the art that while the embodiments described herein comprise storing the encrypted sensitive information at a cloud connector, other computing devices or modules of the first cloud and/or another cloud (that is not the second cloud) may store the encrypted sensitive information, without deviating from the principles disclosed herein. For example, a local storage server, device, and/or internal resource of a first cloud may store the encrypted sensitive information.

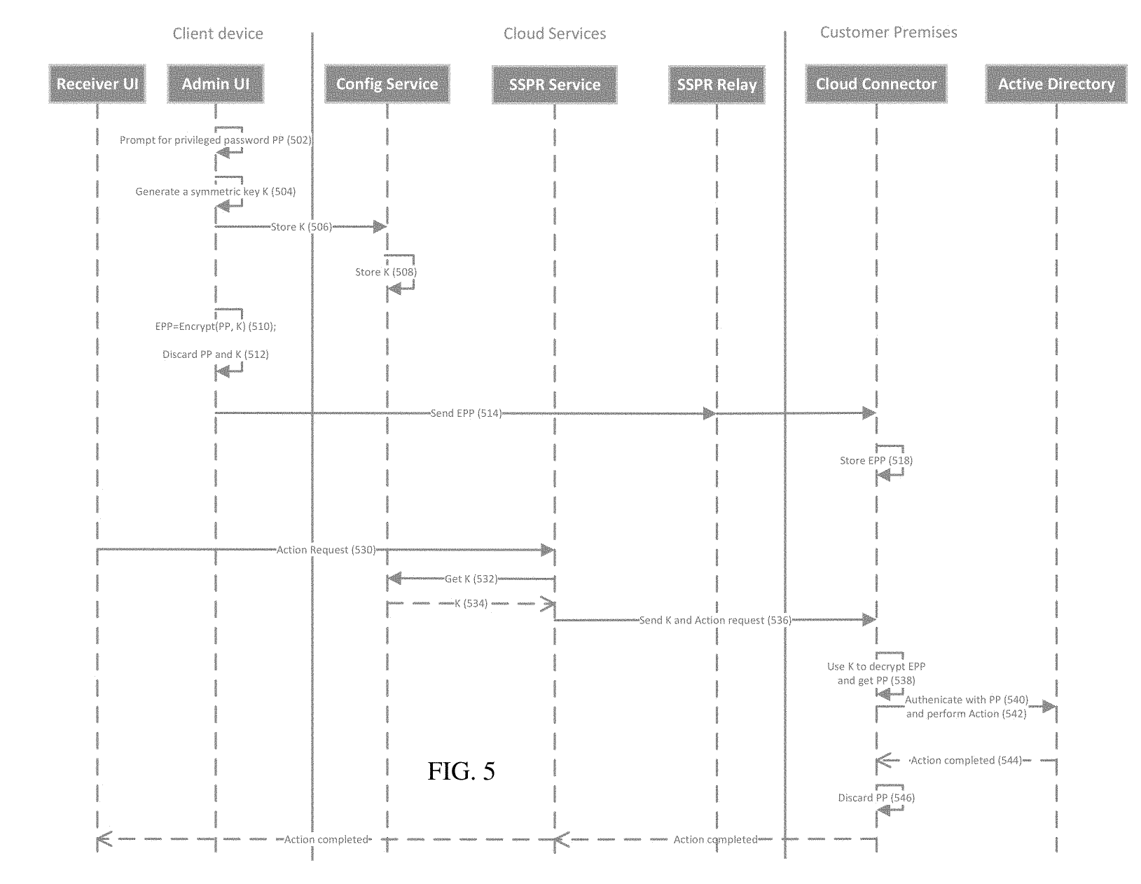

Referring now to FIG. 5, the steps in an example message flow diagram describe a method for secure storage of identity credentials for changing a password using an SSPR service in a cloud computing environment using the methods described herein. It should be noted that while FIG. 5 illustrates a method for the secure storage and transmission of identity credentials (e.g., privileged password of a system administrator) for a self-service password reset service in a cloud computing environment, the embodiments are not so limiting and similar principles may be used for secure storage and transmission of other types of sensitive information in a cloud environment to access other resources (as discussed above).

The message flow may begin at 502 where the Admin UI provided by an external cloud services provider receives identity credentials from a user (e.g., an administrator) for transmission to and/or storage in the cloud environment. In an embodiment, the identity credentials may subsequently be used for authenticating a user requesting a change of password stored in an on-premises active directory, using an SSPR service of an external cloud. In an embodiment, the identity credentials may include any piece of information used to identify and/or authenticate a holder of the credentials, such as a user. For example, credentials include, but are not limited to, user identity (e.g., user number, username, etc.) and/or password, personal identification number (PIN), smart card identity, security certificates (e.g., a public key certificate), and features of the user (e.g., as captured by a sensor, such as a fingerprint reader, iris scan, voice recognizer, or other biometric, etc.), or any data used for authentication to access a particular internal/external application or resource (here the SSPR service).

Typically, identity credentials are stored by the SSPR or another service (such as configuration service) of the external cloud in encrypted and/or unencrypted form. However, such storage is prone to misuse and/or theft of the identity credentials. Thus, the Admin UI may intercept the identity credentials, and encrypt them, as discussed below.

In an embodiment, upon receipt of the identity credentials, the Admin UI may generate an encryption key (504), and encrypt the identity using the encryption key (510) credentials. The Admin UI may transmit the encryption key to the Configuration Service (506) for storage (508) via a first communication channel. The Admin UI may also transmit the encrypted identity credentials to the Cloud Connector (514) for storage (518) via a second communication channel that is separate and distinct from the first communication channel. In an embodiment, the Admin UI may transmit the encrypted identity credentials to the Cloud Connector directly and/or indirectly via another external service (e.g., an SSPR relay). Since the identity credentials are encrypted and stored on the internal cloud and the external cloud only stores the key, the external cloud services provider is not able to access the identity credentials and, thus, security is maintained. Furthermore, use of different communication channels for transmission of the key and the encrypted credentials ensures security from attacks during transmission.

The Admin UI may delete the encryption key as well as the unencrypted identity credentials (512).

At 530, the SSPR service may receive a request for resetting a password or other identity credentials of a user (“action request”) for accessing one or more resources in the internal cloud (e.g., identity credentials stored in an active directory). Upon receipt of the action request, the SSPR may request 532 the encryption key from the configuration service, and may transmit 534 the encryption key along with the action request to the cloud connector. The cloud connector may use the encryption key to decrypt 538 the encrypted identity credentials. The cloud connector may use the decrypted identity credentials to authenticate the user (540), and may transmit the action request (542) to the active directory if the user is authentication is successful. Alternatively and/or additionally, the cloud connector may transmit the decrypted identity credentials along with the action request to the active directory, and the active directory may perform the authentication using the decrypted identity credentials. The active directory may perform the requested action (e.g., password reset) and may send a confirmation (544) to the cloud connector, which may then discard (546) the decrypted identity credentials. The cloud connector may also transmit a message to the user that the requested action was successfully executed.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method for secure storage and transmission of sensitive information in a cloud environment, the method comprising, by a processor:
receiving sensitive information corresponding to a first resource associated with a first cloud;
generating an encryption key for encrypting the sensitive information;
encrypting the sensitive information using the encryption key;
transmitting the encrypted sensitive information to a cloud connector via a first communication channel; and
transmitting the encryption key to a configuration service, wherein the configuration service is associated with a second cloud.

2. The method of claim 1, transmitting the encryption key to the configuration service comprises transmitting the encryption key via a second communication channel, wherein the second communication channel is different from the first communication channel.

3. The method of claim 1, wherein the cloud connector is associated with a cloud that is different from the second cloud.

4. The method of claim 1, further comprising, by the processor, deleting the encryption key after transmission of the encryption key to the configuration service.

5. The method of claim 1, further comprising, receiving by a second resource associated with the second cloud, a request from a user to cause the first resource to perform an action.

6. The method of claim 5, further comprising, by the second resource, in response to receiving the request:
retrieving the encryption key from the configuration service; and
transmitting the encryption key and the request to the cloud connector.

7. The method of claim 6, wherein the encryption key is transmitted to the cloud connector via a third communication channel.

8. The method of claim 1, further comprising, by the cloud connector:
receiving the encryption key from a second resource associated with the second cloud;
using the encryption key to decrypt the encrypted sensitive information;
authenticating the user using the decrypted sensitive information; and
upon successful authentication, transmitting the request to the first resource.

9. The method of claim 6, further comprising, by the cloud connector:
receiving the encryption key from the second resource associated with the second cloud;
using the encryption key to decrypt the encrypted sensitive information; and
transmitting the request and the decrypted sensitive information to the first resource.

10. The method of claim 8, further comprising, by the cloud connector, deleting the decrypted sensitive information.

11. The method of claim 2, wherein one or more of the first communication channel or the second communication channel are secured communication channels.

12. The method of claim 1, wherein the sensitive information comprises identity credentials for authenticating a user requesting access to the first resource.

13. A cloud-based computing system, comprising:
a processor; and
a non-transitory computer-readable storage medium comprising programming instructions that are configured to cause the processor to implement a method for secure storage and transmission of sensitive information in the cloud-based computing system, wherein the programming instructions comprise instructions to:
receive sensitive information corresponding to a first resource associated with a first cloud of the cloud-based computing system;
generate an encryption key for encrypting the sensitive information;
encrypt the sensitive information using the encryption key;
transmit the encrypted sensitive information to a cloud connector via a first communication channel; and
transmit the encryption key to a configuration service, wherein the configuration service is associated with a second cloud of the cloud-based computing system.

14. The system of claim 13, wherein the programming instructions to transmit the encryption key to the configuration service comprises comprise instructions to transmit the encryption key via a second communication channel, wherein the second communication channel is different from the first communication channel.

15. The system according to claim 13, wherein the cloud connector is associated with a cloud that is different from the second cloud.

16. The system of claim 13, wherein the programming instruction further comprise instructions to delete the encryption key after transmission of the encryption key to the configuration service.

17. The system of claim 13, wherein the programming instruction further comprise instructions to, receive, by a second resource associated with the second cloud of the cloud-based computing system, a request from a user to cause the first resource to perform an action.

18. The system of claim 17, wherein the programming instruction further comprise instructions to, by the second resource, in response to receiving the request:
retrieve the encryption key from the configuration service; and
transmit the encryption key and the request to the cloud connector.

19. The system of claim 18, wherein the encryption key is transmitted to the cloud connector via a third communication channel.

20. The system of claim 13, wherein the programming instruction further comprise instructions to cause the cloud connector to:
receive the encryption key from a second resource associated with the second cloud;
use the encryption key to decrypt the encrypted sensitive information;
authenticate the user using the decrypted sensitive information; and
upon successful authentication, transmit the request to the first resource.

21. The system of claim 18, wherein the programming instruction further comprise instructions to cause the cloud connector to:
receive the encryption key from the second resource associated with the second cloud;
use the encryption key to decrypt the encrypted sensitive information; and
transmit the request and the decrypted sensitive information to the first resource.

22. The system of claim 20, wherein the programming instruction further comprise instructions to cause the cloud connector to delete the decrypted sensitive information.

23. The system of claim 14, wherein one or more of the first communication channel or the second communication channel are secured communication channels.

24. The system of claim 13, wherein the sensitive information comprises identity credentials for authenticating a user requesting access to the first resource.
